(19) United States
(12) Patent Application Publication
(10) Pub. No.: US 2026/0323228 A1
(43) Pub. Date: Oct. 15, 2026

(54) Audio Distortion Mitigation

(71) Applicant: Google LLC, Mountain View, CA (US)

(72) Inventors: Liu Wei Liang, Taoyuan (TW); Vincent P. J. Chung, Tucheng District (TW); Pei-Chen Chuang, Taipei (TW)

(73) Assignee: Google LLC, Mountain View, CA (US)

(21) Appl. No.: 18/870,292

(22) PCT Filed: Dec. 13, 2023
(86) PCT No.: PCT/US2023/083802

§ 371 Date: Nov. 27, 2024

(51) Int. Cl. H04R 29/00

(52) U.S. Cl. CPC H04R 29/001; H04R 2499/11

(57) ABSTRACT

Techniques, systems, and apparatuses directed to audio distortion mitigation on a computing device associated with a physical blockage of a speaker port of the device are disclosed. In one example, a computer-implemented method includes generating a sound output corresponding to an audio signal, emitting the sound output from a speaker port defined in a housing of a computing device, receiving first sensor data from at least one first sensor, determining a physical blockage of the speaker port based on the first sensor data, receiving second sensor data from at least one second sensor, and determining a cause of the determined physical blockage of the speaker port. Responsive to determining a cause of the physical blockage of the speaker port, the computing device performs one or more actions to mitigate audio distortion of the sound output from the speaker port.

### BACKGROUND

Handheld computing devices (e.g., smartphones, tablet devices, wearable computing devices, and the like) frequently include one or more speaker ports. A speaker port is an opening (e.g., aperture) defined in the housing of the device that is configured for porting sound generated by an audio output device (e.g., speaker) installed in the housing to the exterior of the housing. For example, a speaker may convert an electrical signal (e.g., an audio signal) into a corresponding sound output (e.g., audio playback), which is emitted from the speaker port. The speaker sound output may include, for example, a playback of an audio recording, streamed audio, and the like.

It is common for a user to hold a handheld computing device in a position where the user's body (e.g., a finger of the user) may block one or more of the speaker ports or a portion thereof. Such a speaker port blockage can result in audio distortion (e.g., a total harmonic distortion (THD) of the speaker sound output) due to the acoustic resonance shift of the speaker(s). A lower audio distortion means that the speaker produces a more accurate reproduction of the audio recording.

### SUMMARY

This disclosure describes techniques, systems, and apparatuses, implemented on computing devices, directed to audio distortion mitigation. In aspects, the techniques, systems, and apparatuses mitigate audio distortion on a computing device associated with a physical blockage of a speaker port of the device.

In some aspects, the techniques described herein relate to a computer-implemented method including: generating a sound output corresponding to an audio signal; emitting the sound output from a speaker port defined in a housing of a computing device; receiving first sensor data from at least one first sensor; determining, based on the first sensor data, a physical blockage of the speaker port; receiving second sensor data from at least one second sensor; determining, based on the second sensor data, a cause of the determined physical blockage of the speaker port; and in response to determining the cause of the physical blockage of the speaker port, causing the computing device to perform one or more actions to mitigate audio distortion of the sound output from the speaker port.

This Summary is provided to introduce simplified concepts of audio distortion mitigation, which are further described below in the Detailed Description and are illustrated in the Drawings.

### BRIEF DESCRIPTION OF THE DRAWINGS

The details of one or more aspects of audio distortion mitigation are described in this disclosure with reference to the following drawings, where the use of same numbers in different instances may indicate similar features or components:

FIGS. 1A and 1B illustrate an example environment in which techniques for audio distortion mitigation can be implemented on a computing device;

FIG. 2 illustrates an implementation of a computing device that can implement techniques for audio distortion mitigation;

FIG. 3 illustrates an implementation of a computing device that can implement techniques for audio distortion mitigation;

FIG. 4 illustrates an implementation of a computing device that can implement techniques for audio distortion mitigation;

FIG. 5 illustrates an implementation of a computing device that can implement techniques for audio distortion mitigation;

FIG. 6 illustrates an implementation of a computing device that can implement techniques for audio distortion mitigation;

FIG. 7 illustrates an example method for audio distortion mitigation in accordance with various aspects;

FIG. 8 illustrates an example method for audio distortion mitigation in accordance with various aspects;

FIG. 9 illustrates an example method for audio distortion mitigation in accordance with various aspects;

FIG. 10 illustrates an example method for audio distortion mitigation in accordance with various aspects;

FIG. 11 illustrates an example method for audio distortion mitigation in accordance with various aspects;

FIG. 12 illustrates an example method for audio distortion mitigation in accordance with various aspects; and

FIG. 13 illustrates an example method for audio distortion mitigation in accordance with various aspects.

### DETAILED DESCRIPTION

### Overview

This disclosure describes techniques, systems, and apparatuses, implemented on computing devices, directed to audio distortion mitigation. In aspects, the techniques, systems, and apparatuses may utilize at least one of sensor data, speaker context information, and/or user activity data to determine the occurrence of a physical blockage of a speaker port. Responsive to such a determination, the techniques, systems, and apparatuses may take actions to manage speaker sound output to mitigate audio distortion. For example, a user equipment device (e.g., computing device, smartphone, tablet device, smart watch, wearable device, and the like) includes a blockage manager system configured to determine an occurrence of a physical blockage of a speaker port by the body of a user of the device and, in response, takes actions to manage speaker sound output to mitigate audio distortion (e.g., by lowering audio distortion, by lowering gain) caused by the physical blockage, resulting in the speaker producing a more accurate reproduction of the audio. The use of “blockage,” “blocked,” and grammatically related terms herein refers to covering, closing, and/or obscuring at least a portion of a speaker port such that the emission of sound through or from the opening is at least partially impeded.

The blockage manager system may take at least one action to manage speaker sound output to mitigate audio distortion. Examples of actions to mitigate audio distortion include, but are not limited to, changing an equalization (EQ) filter or EQ filter setting, changing (e.g., decreasing) an output volume of a speaker, and/or providing a notification (e.g., audible feedback, user interface notification, haptic feedback) to a user. In this way, the blockage manager system may enable a computing device to provide a user of the device with managed speaker sound output to mitigate audio distortion. The managed speaker sound output, in some aspects, may decrease wasted resources (e.g., processor usage, battery usage associated with sound output volume, and the like). Through the management of speaker sound output, the blockage manager system may improve the quality of the user's experience in using the computing device.

In an example use case, a smartphone includes at least one speaker configured for sound output. The speaker is disposed at a speaker port defined in the housing of the smartphone. In such a configuration, during playback, sound output from the speaker emanates at least in part from the speaker port. A user may hold the smartphone in a way that results in the hand (e.g., palm, finger, thumb) or another body part of the user blocking one or more speaker ports of the smartphone, causing audio distortion. The user may be unaware that their body position is a cause of audio distortion, and as a result the user's experience may be impacted (e.g., the user may not adequately hear portions of a conversation while a phone is used in a speaker phone mode, music playing on the speaker may be distorted, etc.).

In contrast, consider the disclosed techniques, systems, and apparatuses, which determine the occurrence of the physical blockage of a speaker port and mitigate the audio distortion caused by the physical blockage. This is but one example of how the described techniques, systems, and apparatuses may be used to mitigate audio distortion on a computing device associated with a physical blockage of a speaker port of the device. Other examples and implementations are described throughout this disclosure. The disclosure now turns to an example operating environment, after which example systems, apparatuses, and methods are described.

### Operating Environment

The following discussion describes an operating environment, techniques that may be employed in the operating environment, and various systems and/or apparatuses in which components of the operating environment can be embodied. In the context of the present disclosure, reference is made to the operating environment by way of example only.

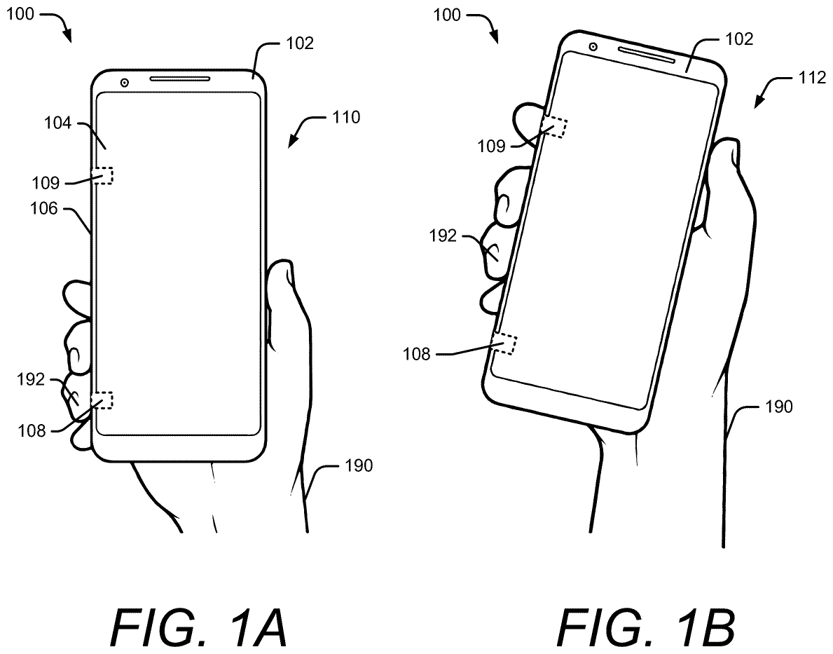

FIGS. 1A and 1B illustrate an example operating environment 100 in which techniques for audio distortion mitigation can be implemented. The example environment 100 includes a user equipment (UE) 102, which includes or is associated with a display 104, a housing 106, and at least one speaker port (e.g., audio port, speaker port 108, speaker port 109) or other opening defined in the housing 106 for porting sound generated by an audio output device (e.g., speaker) installed in the housing 106 to an exterior of the housing 106.

Although the UE (e.g., UE 102) is depicted as a mobile computing device (e.g., a smartphone) in FIGS. 1A-6, the UE may correspond to any type of computing device, including, without limitation, a tablet device, a laptop computer, a desktop computer, a wearable device, a smart watch, a digital assistant device, a smart speaker, a smart display, a smart appliance, an automotive infotainment system, an Internet-of-Things (IoT) device, or the like. The term “wearable device,” as used in this disclosure, refers to any computing device that is capable of being worn at, on, or in proximity to a person's body (e.g., wrist, ankle, waist, chest, other body part), including prosthetic devices (e.g., watch, bracelet, ring, necklace, other jewelry, eyewear, footwear, glove, headwear, clothing, goggles, contact lens).

In FIG. 1A, a user 190 holds the UE 102 in a first position 110 (e.g., in a position where the display 104 is oriented for viewing by the user 190). In the first position 110, the user 190 holds the UE 102 in a way that results in at least a portion of the user's body (e.g., hand, palm, finger, thumb) blocking one or more speaker ports of the UE 102, which may cause audio distortion. For example, in FIG. 1A, a finger 192 of the hand of the user 190 blocks at least a portion of the speaker port 108. In contrast, in FIG. 1B, the user 190 holds the UE 102 in a second position 112 where the user's body does not block one or more speaker ports of the UE 102. For example, in FIG. 1B, the finger 192 of the hand of the user 190 does not block at least a portion of the speaker port 108.

### Systems and Apparatuses

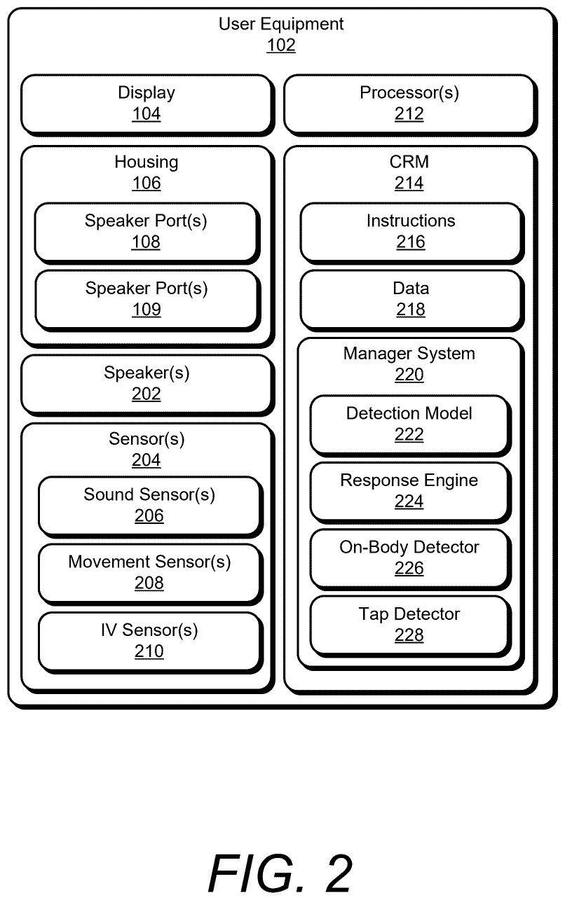

FIG. 2 illustrates an implementation of the UE 102 illustrated in FIGS. 1A and 1B. The UE 102 can implement one or more of the techniques for audio distortion mitigation described herein. The UE 102 includes or is associated with the display 104, the housing 106, and the at least one speaker port (e.g., speaker port 108, speaker port 109) defined in the housing 106. One or more of the speaker ports may be associated with at least one speaker 202 that is configured for sound output.

The UE 102 receives sensor data (aka “sensor input”) from at least one sensor 204, which may generate the sensor data. A sensor 204 may be any of a variety of sensor devices configured to generate sensor data. In aspects, a sensor 204 may include one or more of a sound sensor, a movement sensor, and/or a speaker current and voltage sensor, all of which are described further below. In aspects, a sensor 204 may include a presence sensor for generating presence data indicating a presence of, or proximity to, an object. Examples of presence sensors include touch-sensitive displays, touch sensors (e.g., capacitive sensors, resistive sensors, force-sensing sensors), proximity sensors, mechanical switches, stress sensors, temperature sensors, conductivity sensors, visible light-based sensors, magnetometers, and the like, or any combination thereof. A sensor 204 may include other types of sensors (e.g., force sensors, optical sensors, photon sensors, light sensors, positioning sensors, compasses, temperature sensors, barometric pressure sensors, or any other sensor for generating sensor data).

The UE 102 also includes one or more computer processors 212 (processors 212) and one or more computer-readable media (CRM) 214, which may include memory media and storage media. The computer processors 212 may include an audio processor. The CRM 214 stores information (e.g., instructions 216, data 218) that is accessible to the processors 212. Applications and/or an operating system (not shown) may be implemented as computer-readable instructions 216 on the CRM 214, which can be executed by the processors 212 to provide some or all of the functionalities described herein. For example, some or all of the functions, described below, of one or more of a blockage manager system 220, a blockage detection model 222, a blockage response engine 224, an on-body detector 226, and/or a tap detector 228 may be implemented on the CRM 214. The instructions 216 may include instructions that, when executed by the UE 102 (e.g., by the processors 212 of the UE 102), cause the UE 102 to execute the blockage manager system 220, which may include the blockage detection model 222, the blockage response engine 224, the on-body detector 226, and/or the tap detector 228.

The sensor data may include context information regarding at least one speaker 202, referred to herein as speaker context information. The speaker context information may indicate a context of one or more speakers 202 (e.g., that a speaker port is at least partially blocked, and/or that a user's hand is partially covering a speaker port). The speaker context information may include one or more of audio data, inertial sensor data, or IV sense data. The UE 102 (e.g., blockage manager system 220) may receive and utilize speaker context information to develop the context of at least one speaker 202 (e.g., a speaker port fully covered, a speaker port partially covered, and/or a speaker port uncovered).

The UE 102 (e.g., blockage manager system 220) may receive and utilize other sensor input to develop a context of the UE 102, for example, an indication or characteristic of one or more of an operating environment of the UE 102 or a user activity. The context of the UE 102 may specify one or more of an orientation, acceleration, position, or proximity of the UE 102 to an object. One or more of location (e.g., in a user's hand, in a user's pocket, in a user's bag), temperature, luminance, pressure, and other environmental characteristics may also define the context of the UE 102.

The sensor data may include user activity data associated with a user (e.g., user 190) of the UE 102. User activity data may include an indication or characteristic of a user activity or other user actions. User activity data may indicate a position of a user's hand on the housing 106 of the UE 102 (e.g., placement of the user's fingers and palm, position of a body part of the user relative to the UE 102). In aspects, user activity data may indicate that the user is not holding the UE 102, is holding the UE 102 in a left hand, is holding the UE 102 in a right hand, is holding the UE 102 in both hands in a portrait orientation, is holding the UE 102 in both hands in a landscape orientation, and the like. In aspects, user activity data may relate to movements of the UE 102 (e.g., movements of the UE 102 resulting from user activity): for example, a user tapping on the UE 102 (e.g., providing user input to a touch screen of the UE 102), a user carrying the UE 102 on their body, etc.

The system 220 may be configured to utilize user activity data to detect and classify a user activity (e.g., whether the user 190 is holding the UE 102, how the user 190 is holding the UE 102) that causes a blockage of a speaker port (e.g. speaker port 108, speaker port 109) or a portion thereof by the body of a user. In aspects, a determined user activity may include the user 190 holding the UE 102 in a way that results in at least a portion of the user's body (e.g., hand, palm, finger 192, thumb) blocking one or more speaker ports of the UE 102.

The UE 102 (e.g., blockage manager system 220) may receive and utilize the user activity data to develop a context of the UE 102. One or more of an orientation, acceleration, position, or proximity of the UE 102 to an object and/or an indication or characteristic of an operating environment of the UE 102 may define the context of the UE 102. One or more of location (e.g., in a user's hand, in a user's pocket, in a user's bag), temperature, luminance, pressure, and other environmental characteristics may also define the context of the UE 102.

The system 220 may further be configured to distinguish different speaker contexts and/or user activities by collecting the sensor input according to multiple modalities. The sensor(s) 204 can collect sensor input of a variety of different types, or modalities, including audio signals, optical signals, electromagnetic signals, speaker context information, and/or user activity data.

The blockage manager system 220 (system 220) is configured to determine a blockage of a speaker port (e.g., speaker port 108, speaker port 109) of the UE 102 (e.g., a physical blockage of a speaker port, or a portion thereof, by the body of a user). To make such a determination, the system 220 may utilize speaker context information from a sensor 204 to determine the occurrence of a blockage (or non-blockage) of a speaker port and/or user activity data from a sensor 204 to determine whether a detected speaker port blockage is a physical blockage of the speaker port. For example, the blockage detection model 222 (discussed below) may generate a prediction relating to a blockage of the speaker port 108 of the UE 102 using the sensor data. Responsive to these determinations, the system 220 may take one or more actions to manage speaker sound output to mitigate audio distortion caused by the physical blockage of the speaker port. For example, the blockage response engine 224 (described below) may cause the system 220 to take a particular action to mitigate audio distortion. In aspects, the system 220 may determine that the physical blockage of the speaker port 108 is a user-caused physical blockage of the speaker port (e.g., the hand of the user covering at least a portion of the speaker port).

The speaker 202 is configured to generate a sound output corresponding to an audio signal. In some examples, the system 220 inserts a non-audible tone signal (e.g., a tone signal, an ultrasonic tone signal, an ultrasound signal, a 20 kHz chirp, a 40 kHz chirp) into the audio signal and one or more of the speakers 202 generate a sound output corresponding to the audio signal that includes the tone signal. In some examples, the system 220 may be configured to analyze the sound output to monitor one or more parameters associated with audio signals associated with at least one of the speakers 202 to determine the occurrence of a physical blockage of a speaker port of the UE 102. For example, the system 220 may be configured to monitor a time parameter associated with an audio signal associated with at least one speaker 202 to determine the occurrence of a physical blockage of a speaker port of the UE 102 (e.g., by determining a time-of-flight based on a time-of-departure and a time-of-arrival). In some examples, the system 220 may be configured to determine whether at least one of the monitored parameters associated with the audio signals exceeds a threshold by comparing the monitored parameters to the threshold. In some examples, when the at least one of the monitored parameters exceeds, is below, or meets a threshold, a physical blockage of the speaker port may be determined. In some examples, when at least one of the monitored parameters associated with the non-audible tone signal inserted into the audio signal exceeds, is below, or meets a threshold, a physical blockage of the speaker port may be determined.

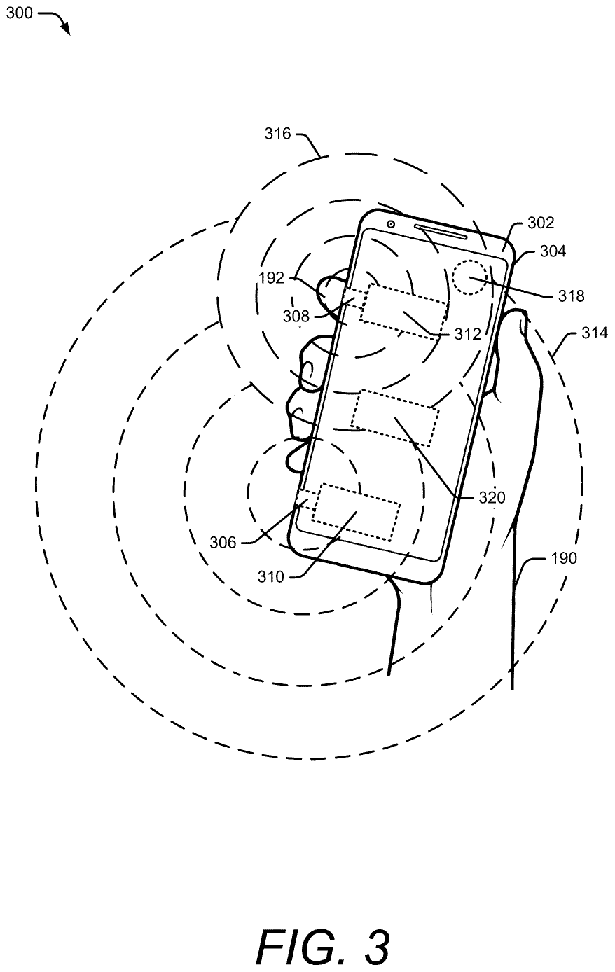

In some examples, each of the speakers 202 may be monitored (e.g., simultaneously, concurrently) by the system 220. For example, the system 220 may monitor one or more parameters per speaker (e.g., speaker 202, first speaker 310 (in FIG. 3), second speaker 312 (in FIG. 3)).

The system 220 may utilize speaker context information from at least one sound sensor 206 (e.g., audio sensor, acoustic sensor, microphone) to determine the occurrence of a blockage of the speaker port 108. The system 220 receives audio data from the sound sensor 206. For example, the sound sensor 206 may detect sound waves and convert them into electrical signals to generate speaker context information, namely, sensor data (e.g., audio data) that corresponds to the received sound output. The system 220 may utilize at least one sound sensor 206 to monitor the sound output of at least one speaker (e.g., speaker 202) of the UE 102 to determine the occurrence of a physical blockage of a speaker port (e.g., speaker port 108) of the UE 102. The system 220 may determine the occurrence of a physical blockage of the speaker port 108 utilizing the audio data generated by the sound sensor 206.

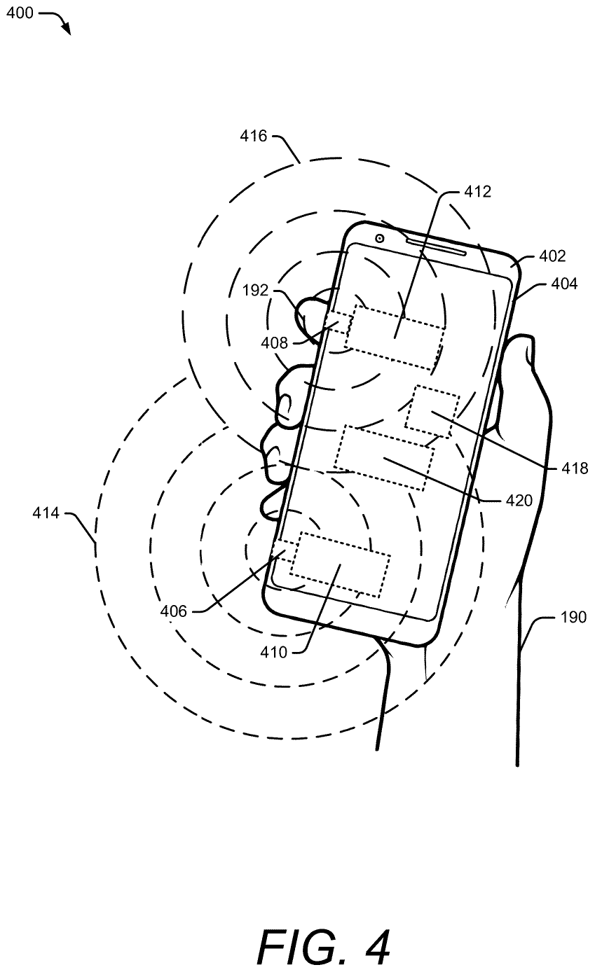

The system 220 may utilize speaker context information from at least one movement sensor 208 to determine the occurrence of a blockage of the speaker port 108. The movement sensor 208 generates speaker context information (e.g., inertial sensor data) that defines a movement of the UE 102 that corresponds to the received sound output. The movement sensor 208 may include one or more of an inertial measurement unit (IMU), an accelerometer, a gyroscope, a magnetometer, a tilt sensor, a force sensor, and the like, or any combination thereof. Movement is here defined to include specific force, angular rate, orientation, vibrations, acceleration, velocity, and position, including pitch, roll, and yaw for each of three axes (e.g., X, Y, and Z). The inertial sensor data may define movements (e.g., vibrations) of the UE 102 responsive to the sound output of the speaker 202, for example, as described with respect to FIG. 4 below.

The system 220 receives the speaker context information (e.g., inertial sensor data) from the movement sensor 208. The speaker context information is utilized by the system 220 to determine the occurrence of a blockage of the speaker port 108. In one example, using inertial sensor data generated by the movement sensor 208, the blockage detection model 222 may generate a prediction relating to a blockage (or non-blockage) of the speaker port 108 of the UE 102.

In aspects, the sensor(s) 204 may include a speaker current and voltage sensor (IV sensor) 210 for detecting an abnormal state of a speaker 202. The IV sensor 210 may perform current-voltage sensing to generate speaker context information (e.g., IV sense data) for the speaker 202 that corresponds to the received sound output, the IV sense data defining a state of the speaker 202. For example, the IV sense data monitored by the IV sensor 210 may be indicative of speaker impedance-the load the speaker 202 places on an audio amplifier associated with the speaker 202. In the example illustrated in FIG. 2, the IV sensor 210 generates IV sense data and the system 220 receives the IV sense data from the IV sensor 210.

In some examples, the system 220 may be configured to monitor IV sense data associated with at least one of the speakers 202 to determine the occurrence of a blockage of a speaker port. In some examples, the system 220 may be configured to monitor one or more parameters associated with IV sense data (e.g., impedance) from the speaker 202. Examples of monitored parameters include, but are not limited to, impedance and resistance. For example, the system 220 may determine that an increase in speaker impedance indicates a blockage of the speaker. In some examples, the system 220 may be configured to determine whether at least one of the monitored parameters associated with the IV sense data exceeds a threshold by comparing the monitored parameters to the threshold. In some examples, each monitored parameter may be associated with a respective threshold (e.g., an impedance threshold, a resistance threshold). In some examples, IV sense data for each speaker of a plurality of speakers 202 may be monitored (e.g., simultaneously, concurrently) by the system 220. For example, the system 220 may monitor one or more parameters per speaker 202.

In some examples, the system 220 may be configured to detect a physical blockage of a speaker port of the UE associated with a monitored parameter of IV sense data associated with a speaker based at least in part on the monitored parameter exceeding the threshold (e.g., an increase in speaker impedance indicating a blockage of a speaker port).

Utilizing the IV sense data from the IV sensor 210, the UE 102 (e.g., system 220 of UE 102) may determine the occurrence of a physical blockage of a speaker port. For example, using IV sense data, the blockage detection model 222 may generate a prediction relating to a blockage (or non-blockage) of a speaker port of the UE 102. In some examples, the system 220 (e.g., blockage response engine 224) of the UE 102 may be configured to take at least one action to manage speaker sound output to mitigate audio distortion of the speaker 202 responsive to determining a blocked port.

The sensor data (e.g., user activity data) may relate to movements of the UE 102. Upon determining a blockage of at least one speaker port (e.g., speaker port 108) of the UE 102, the blockage manager system (e.g., system 220) may utilize the generated user activity data to determine whether the detected speaker port blockage is a physical blockage. In aspects, the system 220 may determine, based on the generated user activity data, that the physical blockage of the speaker port 108 is a user-caused physical blockage of the speaker port (e.g., the hand of the user covering at least a portion of the speaker port).

In a first example, the system 220 implements an on-body detector module (on-body detector 226) that utilizes sensor data (e.g., user activity data) to determine movements of the UE 102 that define an on-body context of the UE 102 indicating that the UE 102 is on the body of the user 190 (e.g., being carried on the body of the user 190). Example movements may include the UE 102 being lifted (e.g., picked up), the UE 102 being oriented toward or away from the user 190, and/or vibrations (e.g., vibrations of the UE 102 as the user 190 is interacting with the UE 102). Movements of the UE 102 may indicate cessation of physical contact by the user 190 of the UE 102, placement of the UE 102 on a non-living object (e.g., table, car console, couch arm, pillow, floor, docking station), placement of the UE 102 within an enclosed container (e.g., pocket, bag, purse), and the like. Further example movements of the UE 102 may include those indicating the UE 102 is being held, movements indicating the UE 102 is being held by a person who is walking, riding a bicycle, riding in a vehicle, or otherwise moving, and movements indicating how the UE 102 is being held, such as a carry-orientation of being in landscape, portrait-up, portrait-down, or a combination thereof. Example movements further include the UE 102 not being held, or movements indicating the UE 102 is not being held but is carried on a person who is walking, etc. The on-body detector 226 may be implemented as a smart lock feature configured to sense (e.g., utilizing sensor data) that the UE 102 is on the body of the user 190 and, for example, keep the UE 102 unlocked when it is on the user 190 and/or when the UE 102 is moving with the user 190. In aspects, the sensor 204 is a movement sensor (e.g., IMU, accelerometer) implemented on the UE 102.

In aspects, the sensor 204 that generates the user activity data (e.g., a movement sensor 208) may be a different sensor than a sensor 204 that generates speaker context information (e.g., an IV sensor 210). In other aspects, the same sensor (e.g., a movement sensor 208) may generate both the user activity data and speaker context information.

Utilizing the determined movements of the UE 102, the on-body detector 226 may determine whether the UE 102 is on the body of a user or is not on the body of a user to determine the occurrence of a physical blockage of a speaker port (e.g., a physical blockage of the speaker port 108 when in a pocket of a garment of the user 190).

User activity data generated by the on-body detector 226 may be provided as input to the blockage detection model 222 and utilized by the blockage detection model 222 to generate data corresponding to a prediction relating to a blockage of a speaker port. The prediction may include whether the blockage is a user-caused physical blockage of the speaker port or whether the blockage is not a user-caused physical blockage of the speaker port.

Responsive to one or more of these determinations, the system 220 may take one or more actions to manage speaker sound output to mitigate audio distortion caused by the physical blockage of the speaker port 108. For example, the blockage response engine 224 (described below) may cause the system 220 to take a particular action to mitigate audio distortion.

In a second example, the system 220 implements a tap detector module (tap detector 228) that utilizes sensor data (e.g., user activity data) to determine movements of the UE 102 caused by the user 190 physically contacting the UE 102 (e.g., a hand of the user 190 gripping the housing 106 of the UE 102, the user 190 tapping on the display 104 of the UE 102). For example, the tap detector 228 may determine, from taps, touches, and other physical contact made by the user 190 with the device, movements of the UE 102 indicative of physical contact by the user 190 with the UE 102. For example, the tap detector 228 may be configured to utilize user activity data (e.g., vibrations of the UE 102 as the user 190 is interacting with the UE 102) to determine a position of at least one body part (e.g., hand, finger) of the user 190 on the housing 106 of the UE 102. In another example, the user activity data includes measurements of body vibrations of the body of a user, interactions between the user holding the device and the device, and the like. Movements of the UE 102 that are caused by the user 190 physically contacting the UE 102 define a tap context of the UE 102 (e.g., an indication of physical interaction by the user 190 with the UE 102).

In aspects, the sensor 204 is a movement sensor (e.g., IMU, accelerometer) implemented on the UE 102. Utilizing the determined movements of the UE 102, the tap detector 228 may determine whether the movements of the UE 102 are caused or are not caused by the user 190 contacting the UE 102. The system 220 may utilize user activity data from the tap detector 228 to determine the occurrence of a user-caused physical blockage of a speaker port (e.g., the physical blockage of the speaker port 108 when an index finger of the user 190 is positioned to cover a first speaker port of the UE 102). In other examples, the user activity data includes measurements of a movement, position, or orientation of the body of the user 190. User activity data generated by the on-body detector 226 may be provided as input to the blockage detection model 222 and utilized by the blockage detection model 222 to generate data corresponding to a prediction relating to a blockage of a speaker port. The blockage detection model 222 may use the user activity data to generate data corresponding to a prediction relating to a blockage of the speaker port 108 of the UE 102, namely, whether a determined blockage of the one or more speaker ports is/are physically blocked by the body of the user 190 or is/are not physically blocked by the body of the user 190.

In aspects, a system may utilize both a tap detector (e.g., tap detector 228) and an on-body detector (e.g., on body detector 226) to determine whether a detected speaker port blockage is a physical blockage (e.g., a user-caused physical blockage of the speaker port).

Responsive to determining a physical blockage of a speaker port, the blockage manager system 220 may take one or more actions to manage speaker sound output to mitigate audio distortion caused by the physical blockage of the speaker port 108. For example, the blockage response engine 224 (described above) may cause the system 220 to take a particular action to mitigate audio distortion.

The system 220 is configured to determine (e.g., based on sensor data generated by one or more sensors), a blockage of a speaker port 108 of the UE 102. In aspects, the system 220 may include or connect to at least one blockage detection model 222 (model 222) implemented on the UE 102 (e.g., on the CRM 214) and/or on a remote computing device (e.g., one or more servers of a distributed system executing in a cloud-computing environment) in communication with the UE 102. The blockage detection model 222 can be any type of model known in the art for performing classifications on input data (e.g., linear classifiers, including logistic regression models, support vector machines, decision trees, neural networks).

The blockage detection model 222 receives (e.g., from the blockage manager system 220, from one or more sensors 204) sensor data as input and generates, as output, a prediction. The sensor data may include one or more of speaker context information and user activity data. A prediction may relate to a blockage of one or more speaker ports, or portions thereof, and/or may relate to whether a determined blockage of a speaker port is a physical blockage of a speaker port by the body of a user of the device. In one example, the blockage detection model 222 receives, as input, speaker context information from a sensor 204 and generates a prediction relating to a blockage of a speaker port of the UE 102. The speaker context information may include one or more of audio data, inertial sensor data, or IV sense data. The prediction may include an identification of what portion of a blocked speaker port is blocked and/or an identification of whether multiple speaker ports are blocked. In another example, the blockage detection model 222 receives, as input, user activity data from a sensor 204 and generates a prediction relating to whether a determined blockage of a speaker port is a physical blockage of a speaker port or is not a physical blockage of a speaker port. In some aspects, the blockage detection model 222 may generate a prediction relating to whether a determined blockage of a speaker port is a user-caused physical blockage of a speaker port or is not a user-caused physical blockage of a speaker port. In some implementations, the system 220 can also implement the blockage detection model 222.

The system 220 is configured to determine (e.g., based on sensor data generated by one or more sensors) an occurrence of a physical blockage of a speaker port by the body of a user of the device. In response to such a determination, the system 220 is configured to take one or more actions to manage speaker sound output to mitigate audio distortion (e.g., lower audio distortion) caused by the physical blockage. Mitigation of audio distortion may result in the speaker producing a more accurate reproduction of the audio. The system 220 may utilize a blockage response engine 224 (response engine 224) to take such actions. The response engine 224 may be implemented on the UE 102 (e.g., on the CRM 214) and configured to cause the UE 102 to take a particular action to manage speaker sound output to mitigate audio distortion in response to a detected physical blockage. In some implementations, the system 220 can also implement the response engine 224.

As discussed above, the system 220 may detect and classify a user activity based on received sensor input. The system 220 may pass the classified activity and corresponding sensor data to the response engine 224. The response engine 224 may be configured to process the classified activity and corresponding sensor data to perform a corresponding action in response (e.g., generating a response or other action to manage speaker sound output that can be performed by the UE 102). Examples of actions to manage speaker sound output include, but are not limited to, applying and/or changing an equalization (EQ) filter, applying and/or changing an EQ filter setting, determining a distorted frequency band(s) and applying an EQ filter to attenuate frequencies in the distorted frequency band(s) (e.g., to lower gain), changing (e.g., decreasing) an output volume of a speaker, turning off a speaker, and providing a notification (e.g., audible feedback, user interface notification, haptic feedback) to a user. Applying an EQ filter and/or EQ filter setting may include performing an EQ change of a sound to be output by the speaker.

In aspects, the system 220 may determine a cessation of a previously determined physical blockage of a speaker port (e.g., determining that a position of the user's body has changed and the speaker port is no longer blocked). Responsive to determining a cessation of a previously determined physical blockage, the system 220 may take an action to undo a previous action to manage speaker sound output (e.g., changing an EQ filter or EQ filter setting to a previous setting, increasing the output volume of a speaker to a previous value, and the like).

The blockage detection model 222 can be trained according to a variety of machine learning training techniques. In some implementations in which the blockage-detection model 222 performs classifications, the blockage-detection model 222 can be trained using supervised learning techniques. For example, the blockage-detection model 222 can be trained on a training dataset that includes training examples labeled as belonging (or not belonging) to one or more classes.

The blockage detection model 222 can be trained by a model trainer implemented on one or more computers located in one or more locations that can each be separate from, or implemented on, the UE 102. In some implementations, the blockage detection model 222 is trained offline by the model trainer and is then loaded into the CRM 214 of the UE 102. In some implementations, the blockage detection model 222 is trained offline by the model trainer but later re-trained or tuned after the blockage detection model 222 is implemented on the UE 102. The model 222 can be trained according to a dataset of training examples representing sensor input and comparing output of the model 222 in detecting user activity against a respective label for each training example. The error between the predicted output of the model 222 and an expected output defined by the labels of the training examples can be computed (for example, using an appropriate loss function (e.g., Mean Square Error)), and then a technique (e.g., backpropagation) can be performed to compute gradients of the loss function with respect to weights of the model 222 to update the weights. The weights for the model 222 can then be updated following gradient calculation, and the process can be repeated (e.g., for a period of time or until arriving at a target accuracy threshold).

FIG. 3 illustrates an example operating environment 300 in which techniques for determining a physical blockage of a speaker port of a device can be implemented. The example operating environment 300 includes a user equipment (UE) 302 held by a user 190. The UE 302 includes a housing 304 and at least one speaker port (e.g., speaker port 306, speaker port 308) or other opening defined in the housing 304 for porting speaker sound to an exterior of the housing 304. The UE 302 is illustrated held by the user 190 with a finger 192 of the hand of the user 190 blocking at least a portion of a speaker port. Sound is generated by at least one audio output device (e.g., first speaker 310, second speaker 312) installed in the housing 304; for example, the first speaker 310 generates a first sound output 314 and the second speaker 312 generates a second sound output 316. The speakers are configured to generate their respective sound outputs corresponding to one or more audio signals. A non-audible tone signal may be inserted into one or more of the audio signals, and one or more of the speakers may generate a sound output corresponding to the audio signal that includes the tone signal. The UE 302 further includes at least one sound sensor 318 (e.g., a microphone) configured to receive at least one of the first sound output 314 or the second sound output 316 and generate sensor data (e.g., audio data) corresponding to the received sound output. For example, the sound sensor 318 may capture and record audio as a digital audio recording, which may include audio recorded over time. A blockage manager system 320 (system 320) of the UE 302 is configured to utilize speaker context information (e.g., the sensor data) to determine a blockage of a speaker port of the UE 302 (e.g., a physical blockage of the speaker port 308, or a portion thereof, by the body of the user).

A determination of an occurrence of a blockage of a speaker port, as described above with respect to the aspects of FIG. 3, may further include generation by a blockage detection model 222 of a prediction relating to a blockage of a speaker port utilizing sensor data.

FIG. 4 illustrates an example operating environment 400 in which techniques for determining a physical blockage of a speaker port of a device can be implemented. The example operating environment 400 includes a UE 402 held by a user 190. The UE 402 includes a housing 404 and at least one speaker port (e.g., speaker port 406, speaker port 408) or other opening defined in the housing 404 for porting sound to an exterior of the housing 404. The UE 402 is illustrated held by the user 190 with a finger 192 of the hand of the user 190 blocking at least a portion of a speaker port. Sound is generated by at least one audio output device (e.g., first speaker 410, second speaker 412) installed in the housing 404. For example, the first speaker 410 may generate a first sound output 414 and the second speaker 412 may generate a second sound output 416. The speakers are configured to generate their respective sound outputs corresponding to one or more audio signals. A non-audible tone signal may be inserted into one or more of the audio signals, and one or more of the speakers may generate a sound output corresponding to the audio signal that includes the tone signal. The UE 402 further includes at least one movement sensor 418 (e.g., an inertial measurement unit (IMU), an accelerometer, a gyroscope) configured to receive at least one of the first sound output 414 or the second sound output 416 and generate sensor data (e.g., inertial sensor data) that defines movement of the UE 402 that corresponds to the received sound output. A blockage manager system 420 (system 420) of the UE 402 is configured to utilize speaker context information (e.g., the sensor data) to determine a blockage of a speaker port of the UE 402 (e.g., a physical blockage of a speaker port, or a portion thereof, by the body of the user).

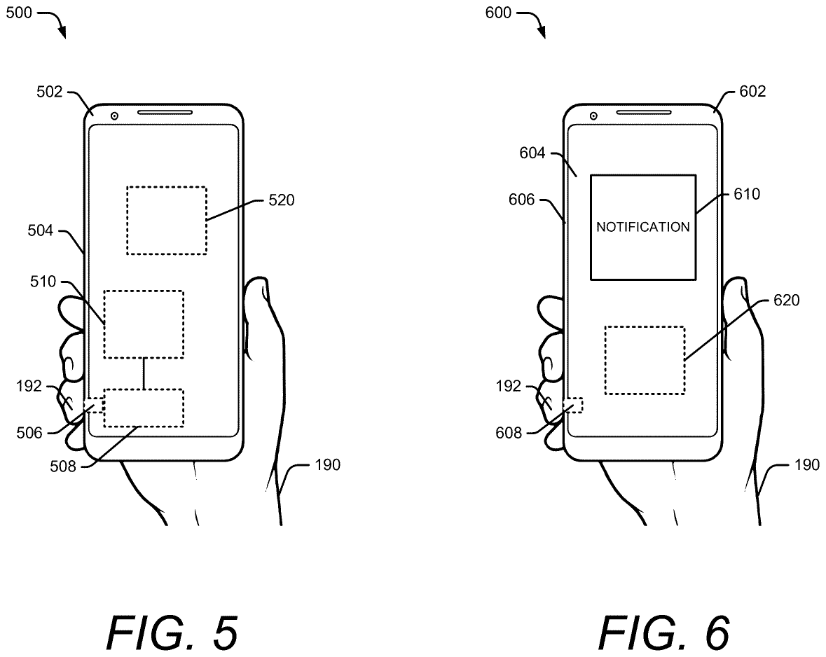

In FIG. 5, an example operating environment 500 includes a user equipment (UE) 502 held by a user 190. The UE 502 includes a housing 504 and at least one speaker port (e.g., speaker port 506) or other opening defined in the housing 504 for porting sound to an exterior of the housing 504. The UE 502 is illustrated held by the user 190 with a finger 192 of the hand of the user 190 blocking at least a portion of a speaker port 506. Sound is generated by at least one audio output device (e.g., speaker 508) installed in the housing 504; for example, the speaker 508 generates a first sound output. The speaker 508 is configured to generate a respective sound output corresponding to one or more audio signals. A non-audible tone signal may be inserted into the audio signal, and the speaker 508 may generate a sound output corresponding to an audio signal that includes the tone signal. The UE 502 further includes at least one IV sensor 510 configured to generate sensor data corresponding to the sound output by the speaker 508. In aspects, the sensor data may include IV sense data corresponding to the received sound output. A blockage manager system 520 (system 520) of the UE 502 is configured to utilize speaker context information (e.g., the IV sense data) to determine a blockage of a speaker port of the UE 502 (e.g., a physical blockage of the speaker port 506, or a portion thereof, by the body of the user).

The description of FIG. 3 discloses techniques for determining a physical blockage of a speaker port of a device using audio data, the description of FIG. 4 discloses techniques for determining a physical blockage of a speaker port of a device using inertial sensor data, and the description of FIG. 5 discloses techniques for determining a physical blockage of a speaker port of a device using IV sense data. In aspects, a blockage manager system may utilize one or more of audio data, inertial sensor data, and/or IV sense data, as described above, to determine the occurrence of a blockage of a speaker port.

In FIG. 6, an example operating environment 600 includes a UE 602 held by a user 190. The UE 602 includes a display 604, a housing 606, and at least one speaker port (e.g., speaker port 608) or other opening defined in the housing 606 for porting sound to an exterior of the housing 606. The UE 602 is illustrated held by the user 190 with a finger 192 of the hand of the user 190 blocking at least a portion of a speaker port 608. The UE 602 (e.g., a blockage manager system 620 of the UE 602) may generate one or more notifications (e.g., notification 610) on the display 604 based on a determination of an occurrence of a blockage of the speaker port 608. The notification 610 may include a message that indicates audio distortion is detected, a message that indicates that the user 190 is blocking a speaker port, and the like. In some examples, the notification 610 may indicate that at least one action to manage speaker sound output to mitigate audio distortion has been automatically implemented by the UE 602. In some examples, the notification 610 may include a graphical button (e.g., a notification prompt on a graphical user interface of the UE 102) and a query that asks for user input regarding an action to manage speaker sound output to mitigate audio distortion.

### Example Methods

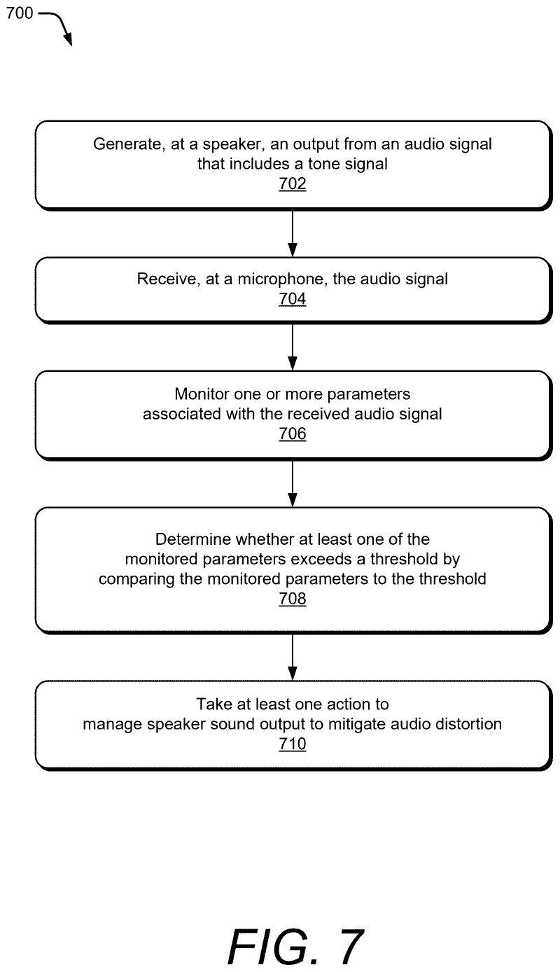

This section describes example methods, implemented on computing devices, directed to audio distortion mitigation. In aspects, the methods mitigate audio distortion on a computing device (e.g., UE 102) associated with a physical blockage of a speaker port of the device. The example methods may operate separately or together in whole or in part. Example methods of operation directed to audio distortion mitigation in accordance with various embodiments will now be described with respect to the flowcharts of FIG. 7 through FIG. 12. The flowcharts of FIGS. 7-12 are described with respect to the operating environments (e.g., operating environment 100) and the UE (e.g., UE 102) described and illustrated in FIGS. 1A, 1B, and 2-6, which are useful for understanding the operations.

FIG. 7 illustrates an example method 700 performed by a computing device (e.g., UE 302 of FIG. 3) for determining the occurrence of a blockage of a speaker port. The method 700 is illustrated as a set of operational blocks that specify operations performed but are not necessarily limited to the order or combinations shown for performing the operations. Further, one or more of the operations may be repeated, combined, reorganized, reordered, or linked to provide a wide array of additional and/or alternate methods (e.g., methods 800-1300). The techniques are not limited to performance by one entity or multiple entities operating on one device. In FIG. 7, at 702, at least one speaker generates an output (e.g., sound output) from an audio signal that includes a non-audible tone signal. For example, in the aspect illustrated in FIG. 3, the first speaker 310 generates the first sound output 314 from a first audio signal that includes a first tone signal. Optionally, the second speaker 312 may generate the second sound output 316 from a second audio signal that includes a second tone signal. The first and second audio signals and the first and second tone signals may be the same signals or may be different signals. At 704, a blockage manager system (e.g., blockage manager system 320) implemented on the UE (e.g., UE 302) receives the audio signal(s) using at least one sound sensor (e.g., sound sensor 318). The blockage manager system monitors, at 706, one or more parameters associated with the received audio signals and determines, at 708, whether at least one of the monitored parameters associated with the audio signals exceeds a threshold by comparing the monitored parameters to the threshold. Responsive to determining that the threshold has been exceeded, at 710, the blockage manager system takes at least one action to manage speaker sound output to mitigate audio distortion.

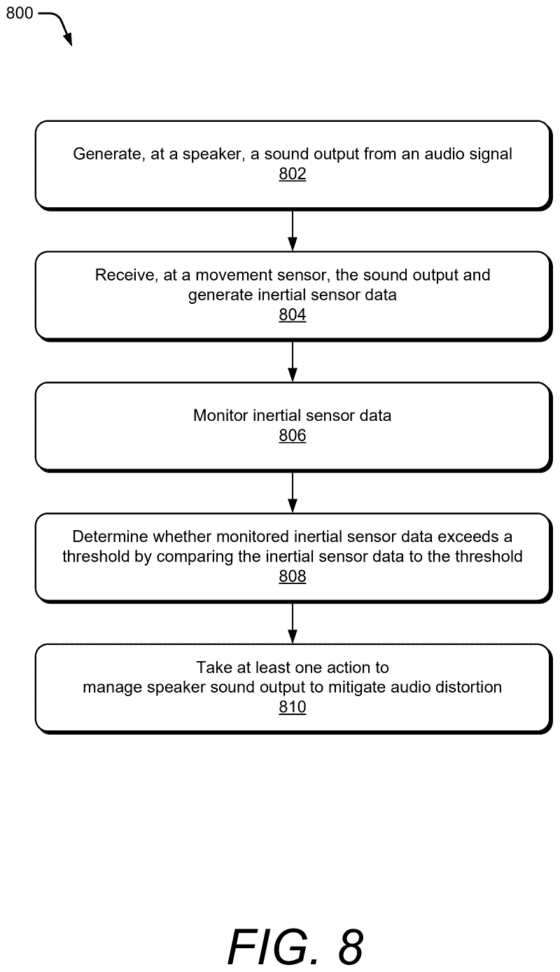

FIG. 8 illustrates an example method 800 performed by a computing device (e.g., UE 402) for determining the occurrence of a blockage of a speaker port. The method 800 is illustrated as a set of operational blocks that specify operations performed but are not necessarily limited to the order or combinations shown for performing the operations. Further, one or more of the operations may be repeated, combined, reorganized, reordered, or linked to provide a wide array of additional and/or alternate methods (e.g., methods 700, 900-1300). The techniques are not limited to performance by one entity or multiple entities operating on one device. In FIG. 8, at 802, at least one speaker generates an output (e.g., sound output) from an audio signal that includes a non-audible tone signal. For example, in the aspect illustrated in FIG. 4, the first speaker 410 generates the first sound output 414 from a first audio signal that includes a first tone signal. Optionally, the second speaker 412 may generate the second sound output 416 from a second audio signal that includes a second tone signal. The first and second audio signals and the first and second tone signals may be the same signals or may be different signals. At 804, a blockage manager system (e.g., blockage manager system 420) implemented on the UE (e.g., UE 402) receives the sound output using at least one movement sensor (e.g., movement sensor 418) and generates sensor data (e.g., inertial sensor data) corresponding to the sound output received. The blockage manager system monitors, at 806, one or more parameters associated with the generated inertial sensor data and determines, at 808, whether at least one of the monitored parameters exceeds a threshold by comparing the monitored parameters to the threshold. Responsive to determining that the threshold has been exceeded, at 810, the blockage manager system takes at least one action to manage speaker sound output to mitigate audio distortion.

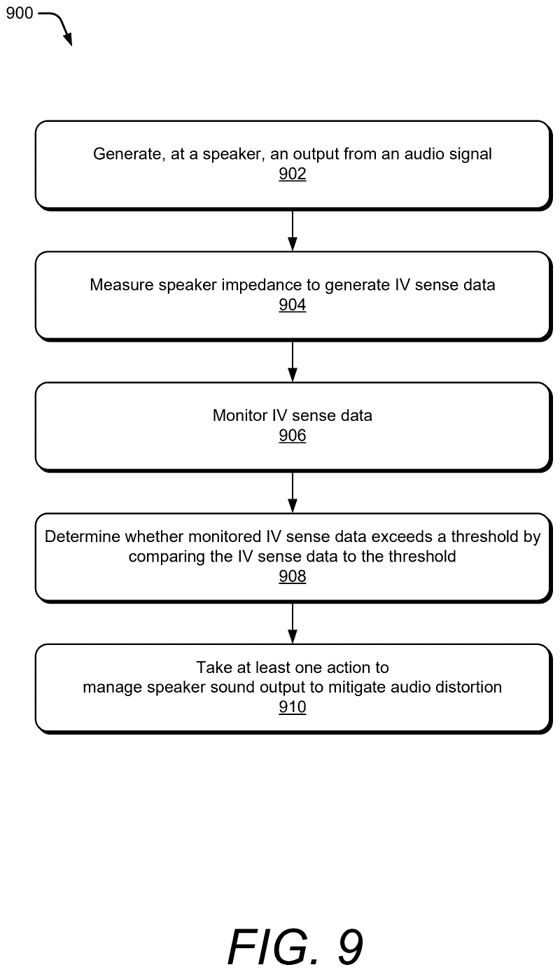

FIG. 9 illustrates an example method 900 performed by a computing device (e.g., UE 502) for determining the occurrence of a blockage of a speaker port. The method 900 is illustrated as a set of operational blocks that specify operations performed but are not necessarily limited to the order or combinations shown for performing the operations. Further, one or more of the operations may be repeated, combined, reorganized, reordered, or linked to provide a wide array of additional and/or alternate methods (e.g., methods 700, 800, and 1000-1300). The techniques are not limited to performance by one entity or multiple entities operating on one device. In FIG. 9, at 902, at least one speaker (e.g., speaker 508) generates an output (e.g., sound output) from an audio signal. At 904, an IV sensor (e.g., IV sensor 510) measures the impedance of the speaker to generate IV sense data. A blockage manager system (e.g., blockage manager system 520) implemented on the UE monitors, at 906, the IV sense data and determines, at 908, whether the IV sense data exceeds a threshold by comparing the IV sense data to the threshold. Responsive to determining that the threshold has been exceeded, at 910, the blockage manager system takes at least one action to manage speaker sound output to mitigate audio distortion.

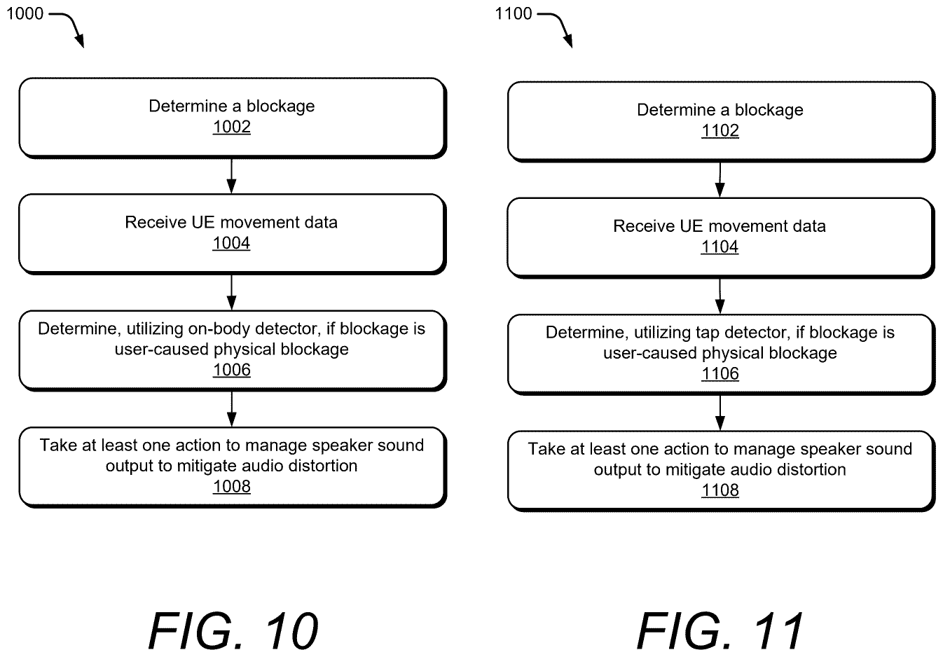

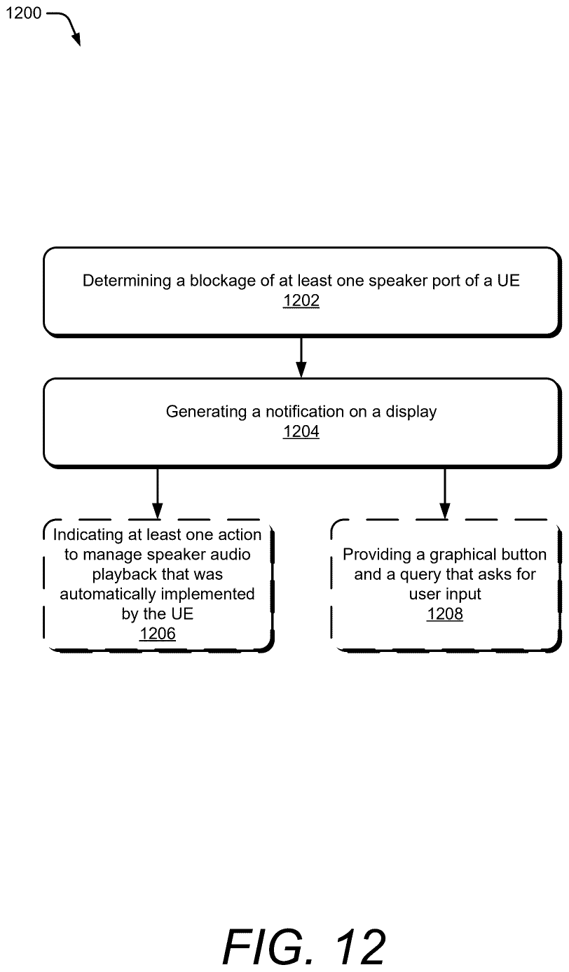

FIG. 10 illustrates an example method 1000 performed by a computing device (e.g., UE 102) for determining the occurrence of a blockage of a speaker port. The method 1000 is illustrated as a set of operational blocks that specify operations performed but are not necessarily limited to the order or combinations shown for performing the operations. Further, one or more of the operations may be repeated, combined, reorganized, reordered, or linked to provide a wide array of additional and/or alternate methods (e.g., methods 700-900 and 1100-1300). The techniques are not limited to performance by one entity or multiple entities operating on one device. In FIG. 10, at 1002, a blockage manager system (e.g., blockage manager system 220) determines a blockage of at least one speaker port of a UE (e.g., UE 102). At 1004, user activity data is received from a movement sensor (e.g., movement sensor 208). At 1006, the user activity data is utilized by an on-body detector (e.g., on-body detector 226) to determine if the blockage of the at least one speaker port of the UE is a physical blockage (e.g., a user-caused physical blockage). Responsive to determining a physical blockage of the speaker port, at 1008, the blockage manager system takes at least one action to manage speaker sound output to mitigate audio distortion. The method 1000 may use elements of one or more of FIGS. 7-9 and/or FIGS. 11-13.

FIG. 11 illustrates an example method 1100 performed by a computing device (e.g., UE 102) for determining the occurrence of a blockage of a speaker port. The method 1100 is illustrated as a set of operational blocks that specify operations performed but are not necessarily limited to the order or combinations shown for performing the operations. Further, one or more of the operations may be repeated, combined, reorganized, reordered, or linked to provide a wide array of additional and/or alternate methods (e.g., methods 700-1000, 1200, and 1300). The techniques are not limited to performance by one entity or multiple entities operating on one device. In FIG. 11, at 1102, a blockage manager system (e.g., blockage manager system 220) determines a blockage of at least one speaker port of a UE (e.g., UE 102). At 1104, user activity data is received from a movement sensor (e.g., movement sensor 208). At 1106, the user activity data is utilized by a tap detector (e.g., tap detector 228) to determine if the blockage of the at least one speaker port of the UE is a physical blockage. Responsive to determining a physical blockage of the speaker port, at 1108, the blockage manager system takes at least one action to manage speaker sound output to mitigate audio distortion.

FIG. 12 illustrates an example method 1200 performed by a computing device (e.g., UE 102) for determining the occurrence of a blockage of a speaker port. The method 1200 is illustrated as a set of operational blocks that specify operations performed but are not necessarily limited to the order or combinations shown for performing the operations. Further, one or more of the operations may be repeated, combined, reorganized, reordered, or linked to provide a wide array of additional and/or alternate methods (e.g., methods 700-1100 and 1300). The techniques are not limited to performance by one entity or multiple entities operating on one device. In FIG. 12, at 1202, a blockage manager system (e.g., blockage manager system 220) determines a blockage of at least one speaker port of a UE (e.g., UE 102). At 1204, the blockage manager system generates one or more notifications (e.g., notification 610) on a display (e.g., display 604) of the UE. At 1206, the display includes an indication of at least one action to manage speaker sound output to mitigate audio distortion has been automatically implemented by the UE. At 1208, a graphical button (e.g., a notification prompt on a graphical user interface of the UE 102) and a query that asks for user input regarding an action to manage speaker sound output to mitigate audio distortion is provided on the display.

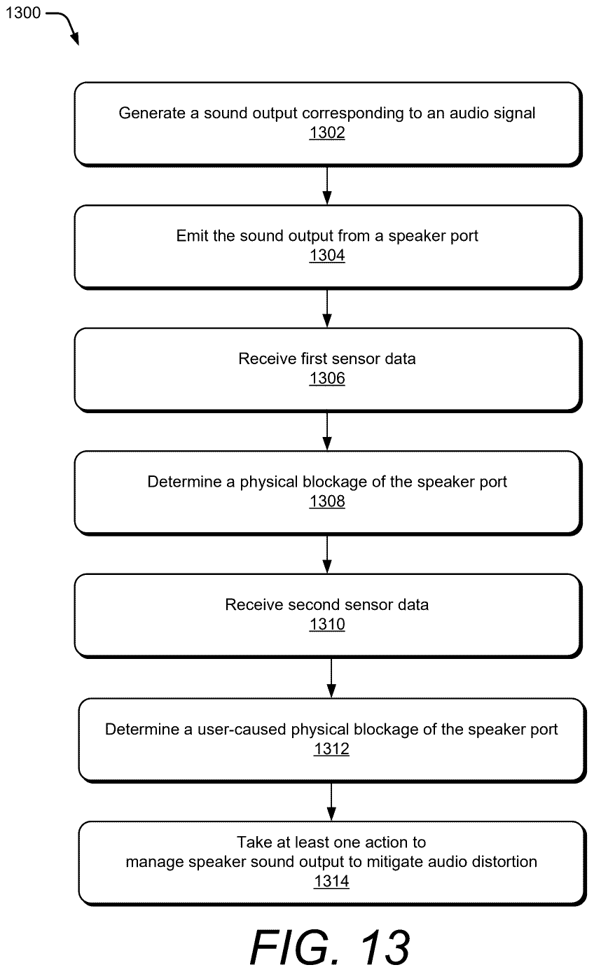

FIG. 13 illustrates an example method for audio distortion mitigation in accordance with various aspects. FIG. 13 depicts an example method 1300 performed by a computing system in accordance with one or more aspects directed to audio distortion mitigation and is one example of a method directed to audio distortion mitigation. The method 1300 is illustrated as a set of operational blocks 1302-1314 that specify operations performed but are not necessarily limited to the order or combinations shown for performing the operations. Further, one or more of the operations may be repeated, combined, reorganized, reordered, or linked to provide a wide array of additional and/or alternate methods disclosed herein (e.g., methods 700-1200). The techniques are not limited to performance by one entity or multiple entities operating on one device. In FIG. 13, at 1302, a sound output corresponding to an audio signal is generated. At 1304, the sound output is emitted from a speaker port defined in a housing of a computing device. At 1306, first sensor data is received from at least one first sensor. At 1308, based on the first sensor data, a physical blockage of the speaker port is determined. At 1310, second sensor data is received from at least one second sensor. At 1312, based on the second sensor data, it is determined whether the determined physical blockage of the speaker port is a physical blockage of the speaker port (e.g., a user-caused physical blockage). In response to determining a physical blockage of the speaker port, at 1314, the computing device performs one or more actions to mitigate audio distortion of the sound output from the speaker port.

Throughout this disclosure, examples are described where a computing system (e.g., the UE, a computing device, a server device, a computer, or another type of computing system) may analyze information (e.g., sensor data, speaker context information, user activity data) associated with a user (e.g., the sound output of a speaker of a device, a user's hand position, a user's body part blocking one or more speaker ports of a device). Further to the descriptions above, a user may be provided with controls allowing the user to make an election as to both if and when systems, programs, and/or features described herein may enable collection of information (e.g., information about a user's social network, social actions, social activities, or profession, a user's preferences, a user's current location), and if the user is sent content or communications from a server.

The computing system can be configured to only use the information after the computing system receives explicit permission from the user of the computing system to use the data. For example, in situations where the UE analyzes sensor data of a sound output to determine the occurrence of a physical blockage of a speaker port of the device, individual users may be provided with an opportunity to provide input to control whether programs or features of the UE can collect and make use of the data. Further, individual users may have constant control over what programs can or cannot do with the information. In addition, information collected may be pre-treated in one or more ways before it is transferred, stored, or otherwise used, so that personally identifiable information is removed. For example, before the UE shares sensor data with another device (e.g., to train a model executing at another device), the UE may pre-treat the sensor data to ensure that any user-identifying information or device-identifying information embedded in the data is removed. In a further example, a user's identity may be treated so that no personally identifiable information can be determined for the user, or a user's geographic location may be generalized where location information is obtained (for example, to a city, ZIP code, or state level) so that a particular location of the user cannot be determined. Thus, the user may have control over whether information is collected about the user and the user's device and how such information, if collected, may be used by the computing device and/or a remote computing system.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

### EXAMPLES

In this section, examples are provided.

Example 1. A computer-implemented method comprising: generating a sound output corresponding to an audio signal; emitting the sound output from a speaker port defined in a housing of a computing device; receiving first sensor data from at least one first sensor; determining, based on the first sensor data, a physical blockage of the speaker port; receiving second sensor data from at least one second sensor; determining, based on the second sensor data, a cause of the determined physical blockage of the speaker port; and in response to determining the cause of the physical blockage of the speaker port, causing the computing device to perform one or more actions to mitigate audio distortion of the sound output from the speaker port.

Example 2. The computer-implemented method of Example 1, wherein the determined cause of the determined physical blockage of the speaker port is a user-caused physical blockage of the speaker port.

Example 3. The computer-implemented method of Example 1, wherein the at least one first sensor is a sound sensor configured to generate audio data that corresponds to the sound output.

Example 4. The computer-implemented method of Example 1, wherein the at least one first sensor is a movement sensor configured to generate inertial sensor data that corresponds to the sound output, the inertial sensor data defining a movement of the computing device.

Example 5. The computer-implemented method of Example 1, wherein the sound output corresponding to an audio signal is generated by a speaker, and wherein the at least one first sensor is a speaker current and voltage sensor configured to generate voltage and current sense data that corresponds to the sound output, the voltage and current sense data defining a state of the speaker.

Example 6. The computer-implemented method of a preceding Example, further comprising: inserting a non-audible tone signal into the audio signal to generate the sound output, the sound output corresponding to the audio signal including the non-audible tone signal.

Example 7. The computer-implemented method of a preceding Example, wherein the at least one second sensor is a movement sensor generating inertial sensor data that defines movements of the computing device.

Example 8. The computer-implemented method of Example 7, further comprising: utilizing the inertial sensor data of the second sensor to determine movements of the computing device indicative of physical contact with the computing device by a user.

Example 9. The computer-implemented method of one of Examples 1-5, wherein the first sensor and the second sensor are different sensors.

Example 10. The computer-implemented method of one of Examples 1-5, wherein the second sensor data comprises user activity data, wherein determining the cause of the determined physical blockage of the speaker port comprises: implementing an on-body detector module configured to utilize the user activity data to determine movements of the computing device that define an on-body context of the computing device, wherein responsive to determining the on-body context of the computing device indicating that the computing device is on the body of a user, the cause of the determined physical blockage of the speaker port is determined to be a user-caused physical blockage of the speaker port.

Example 11. The computer-implemented method of one of Examples 1-5, wherein the second sensor data comprises user activity data, wherein determining the cause of the determined physical blockage of the speaker port comprises: implementing a tap detector module configured to utilize user activity data to determine movements of the computing device that define a tap context of the computing device indicating physical interaction by the user with the computing device, wherein responsive to determining a tap context of the computing device indicating physical interaction by the user with the computing device, the cause of the determined physical blockage of the speaker port is determined to be a user-caused physical blockage of the speaker port.

Example 12. The computer-implemented method of Example 1, wherein the sound output is generated by a speaker, and wherein the one or more actions to mitigate audio distortion of sound output from the speaker port comprise at least one of: lowering a sound volume of the sound output of the speaker; applying an equalization filter to the sound output of the speaker; or displaying a notification prompt on a graphical user interface of the computing device.

Example 13. The computer-implemented method of a preceding Example, further comprising at least one of: processing at least one of the first sensor data or the second sensor data through a blockage detection model trained to receive sensor data from a plurality of sensors comprising the first sensor and to generate data corresponding to a prediction of whether the speaker port is blocked or is not blocked; or processing at least one of the first sensor data or the second sensor data through a body detection model trained to receive sensor data from a plurality of sensors comprising the second sensor and to generate data corresponding to a prediction of whether the cause of the determined physical blockage of the speaker port is the speaker port being physically blocked by the body of the user or not physically blocked by the body of the user.

Example 14. A computing system comprising: a processor; a blockage manager system; and a memory having instructions stored thereon that, responsive to execution by the processor or the blockage manager system, cause the blockage manager system to execute the method of any of Examples 1 to 13.

Example 15. A computer program comprising instructions that, when executed by a processor, cause the processor to perform the method of any of Examples 1 to 13.

Example 16. The computer-implemented method of a preceding Example, wherein the sound sensor configured to generate audio data that corresponds to the sound output is a microphone.

Example 17. The computer-implemented method of a preceding Example, wherein at least one of the first sensor or the second sensor is a movement sensor, and optionally an inertial measurement unit (IMU).

Example 18. The computer-implemented method of a preceding Example, wherein the movement sensor is an inertial measurement unit (IMU).

Example 19. The computer-implemented method of a preceding Example, further comprising analyzing the first sensor data corresponding to the sound output to determine a physical blockage of the speaker port.

Example 20. A computer-implemented method comprising: generating a sound output corresponding to an audio signal; emitting the sound output from a speaker port defined in a housing of a computing device; receiving first sensor data from at least one first sensor; determining, based on the first sensor data, a physical blockage of the speaker port; receiving second sensor data from at least one second sensor; determining, based on the second sensor data, whether the determined physical blockage of the speaker port is a user-caused physical blockage of the speaker port; and in response to determining that the physical blockage of the speaker port is a user-caused physical blockage of the speaker port, causing the computing device to perform one or more actions to mitigate audio distortion of the sound output from the speaker port.

### Conclusion

Although implementations of techniques, systems, and apparatuses, implemented on computing devices, directed to audio distortion mitigation have been described in language specific to features and/or methods, it is to be understood that the subject of the appended claims is not necessarily limited to the specific features or methods described. Rather, the specific features and methods are disclosed as example implementations of techniques, systems, and apparatuses, implemented on computing devices, directed to audio distortion mitigation.

1. A computer-implemented method comprising:
generating a sound output corresponding to an audio signal;
emitting the sound output from a speaker port defined in a housing of a computing device;
receiving first sensor data that corresponds to the sound output from at least one first sensor;
determining, based on the first sensor data, a physical blockage of the speaker port;
receiving second sensor data from at least one second sensor;
determining, based on the second sensor data, a cause of the determined physical blockage of the speaker port; and
in response to determining the cause of the physical blockage of the speaker port, causing the computing device to perform one or more actions to mitigate audio distortion of the sound output from the speaker port.

2. The computer-implemented method of claim 1, wherein the determined cause of the determined physical blockage of the speaker port is a user-caused physical blockage of the speaker port.

3. The computer-implemented method of claim 1, wherein the at least one first sensor is a sound sensor configured to generate audio data that corresponds to the sound output.

4. The computer-implemented method of claim 1, wherein the at least one first sensor is a movement sensor configured to generate inertial sensor data that corresponds to the sound output, the inertial sensor data defining a movement of the computing device.

5. The computer-implemented method of claim 1,
wherein the sound output corresponding to an audio signal is generated by a speaker.

6. The computer-implemented method of claim 1, further comprising:
inserting a non-audible tone signal into the audio signal to generate the sound output, the sound output corresponding to the audio signal including the non-audible tone signal.

7. The computer-implemented method of a claim 1, wherein the at least one second sensor is a movement sensor generating inertial sensor data that defines movements of the computing device.

8. The computer-implemented method of claim 7, further comprising:
utilizing the inertial sensor data of the second sensor to determine movements of the computing device indicative of physical contact with the computing device by a user.

9. The computer-implemented method of claim 1, wherein the first sensor and the second sensor are different sensors.

10. The computer-implemented method of claim 1,
wherein the second sensor data comprises user activity data,
wherein determining the cause of the determined physical blockage of the speaker port comprises:
implementing an on-body detector module configured to utilize the user activity data to determine movements of the computing device that define an on-body context of the computing device,
wherein responsive to determining the on-body context of the computing device indicating that the computing device is on a body of a user, the cause of the determined physical blockage of the speaker port is determined to be a user-caused physical blockage of the speaker port.

11. The computer-implemented method of claim 1,
wherein the second sensor data comprises user activity data,
wherein determining the cause of the determined physical blockage of the speaker port comprises:
implementing a tap detector module configured to utilize user activity data to determine movements of the computing device that define a tap context of the computing device indicating physical interaction by the user with the computing device,
wherein responsive to determining a tap context of the computing device indicating physical interaction by the user with the computing device, the cause of the determined physical blockage of the speaker port is determined to be a user-caused physical blockage of the speaker port.

12. The computer-implemented method of claim 1, wherein the sound output is generated by a speaker.

13. The computer-implemented method of claim 1, further comprising:
processing at least one of the first sensor data or the second sensor data through a blockage detection model trained to receive sensor data from a plurality of sensors comprising the first sensor and to generate data corresponding to a prediction of whether the speaker port is blocked or is not blocked.

14. (canceled)

15. (canceled)

16. The computer-implemented method of claim 1, further comprising:
processing at least one of the first sensor data or the second sensor data through a body detection model trained to receive sensor data from a plurality of sensors comprising the second sensor and to generate data corresponding to a prediction of whether the cause of the determined physical blockage of the speaker port is the speaker port being physically blocked by a body of a user or not physically blocked by the body of the user.

17. The computer-implemented method of claim 12, wherein the one or more actions to mitigate audio distortion of sound output from the speaker port comprises lowering a sound volume of the sound output of the speaker.

18. The computer-implemented method of claim 12, wherein the one or more actions to mitigate audio distortion of sound output from the speaker port comprises applying an equalization filter to the sound output of the speaker.

19. The computer-implemented method of claim 12, wherein the one or more actions to mitigate audio distortion of sound output from the speaker port comprises displaying a notification prompt on a graphical user interface of the computing device.

20. The computer-implemented method of claim 5, wherein the at least one first sensor is a speaker current and voltage sensor configured to generate voltage and current sense data that corresponds to the sound output, the voltage and current sense data defining a state of the speaker.

21. A computing system comprising:
a processor;
a blockage manager system; and
a memory having instructions stored thereon that, responsive to execution by the processor or the blockage manager system, cause the blockage manager system to:
generate a sound output corresponding to an audio signal;
emit the sound output from a speaker port defined in a housing of a computing device;
receive first sensor data that corresponds to the sound output from at least one first sensor;
determine, based on the first sensor data, a physical blockage of the speaker port;
receive second sensor data from at least one second sensor;
determine, based on the second sensor data, a cause of the determined physical blockage of the speaker port; and
in response to determining the cause of the physical blockage of the speaker port, cause the blockage manager system to perform one or more actions to mitigate audio distortion of the sound output from the speaker port.

22. A computer-readable storage medium comprising instructions that, when executed, configure at least one processor to:
generate a sound output corresponding to an audio signal;
emit the sound output from a speaker port defined in a housing of a computing device;
receive first sensor data that corresponds to the sound output from at least one first sensor;
determine, based on the first sensor data, a physical blockage of the speaker port;
receive second sensor data from at least one second sensor;
determine, based on the second sensor data, a cause of the determined physical blockage of the speaker port; and
in response to determining the cause of the physical blockage of the speaker port, cause the processor to perform one or more actions to mitigate audio distortion of the sound output from the speaker port.
